(19) United States
(12) Patent Application Publication
(10) Pub. No.: US 2009/0321102 A1
(43) Pub. Date: Dec. 31, 2009

(54) HAND-HELD POWER TOOL

(76) Inventor: Aldo Di Nicolantonio, Recherswil (CH)

Correspondence Address: MICHAEL J. STRIKER, 103 EAST NECK ROAD, HUNTINGTON, NY, 11743, US

(21) Appl. No.: 12/304,227

(22) PCT Filed: Feb. 7, 2008
(86) PCT No.: PCT/EP2008/051506

§ 371 Date: Dec. 10, 2008

(30) Foreign Application Priority Data
Mar. 28, 2007 (DE) 102007014756.4

(51) Int. Cl. B25F 5/00; B23Q 5/12

(52) U.S. Cl. 173/178; 173/47

(57) ABSTRACT

The invention relates to a hand tool (1), particularly electric hand tool, having a drive (5), a tool shaft (3), a first overload clutch (14) and a transmission (6), which comprises a first and at least one second gear wheel unit (7, 8), said gear wheel units being operable alternatively to transmit torque. According to the invention, at least one second overload clutch (18) is provided and is permanently and exclusively operatively connected to the first gear wheel unit (7).

### BACKGROUND INFORMATION

The present invention relates to a hand-held power tool, in particular an electrical hand-held power tool, preferably a drill, a rotary hammer, or a cordless screwdriver, according to the preamble of claim 1.

Hand-held power tools which include a drive motor designed as an electric motor in particular have been known for a long time. To work with various materials and/or tools, in particular drilling tools, it is known to equip hand-held power tools with a gearbox which is designed, in particular, as a two-stage spur gearbox. To protect the operator from high reaction moments of the hand-held power tool, and to protect the gearbox from overload, it is known to situate an overload clutch in the drive train as a torque-limiting device, via which the maximum torque to be transferred to the tool shaft and/or the tool which is driven in a rotating manner is limited. When a maximum torque (triggering torque) is exceeded, the power flow between the drive (electric motor) and the tool—which is driven in a rotating manner by the tool shaft—is interrupted as quickly as possible, in order to protect the operator and the workpiece and/or product being machined. A disadvantage of the known hand-held power tools is the fact that the same maximum torque is always transferred, independently of the which gear ratio is selected. It is not possible to make a selection between different maximum torques for different gear ratios when the overload clutch is located on the tool spindle. If the overload clutch is located on a countershaft, the torque which is transferred is determined by the gear ratio. It is not possible to select the triggering torque independently of this.

In addition to the known hand-held power tools which include a single, non-adjustable overload clutch, hand-held power tools are known which include an adjustable overload clutch which are used to adjust the maximum torque that may be transferred depending on the particular task. To vary the torque, the spring force of a closing spring which acts on a coupling part of the overload clutch—in particular a rigid, locking clutch—is varied. The disadvantage of this type of hand-held power tool is that the adjustable overload clutch is susceptible to interference due to its relatively complex design, and that two different switches with separate gearshift linkages must be utilized in order to actuate the gearbox and select the triggering torque.

### DISCLOSURE OF THE INVENTION

### Technical Object

The object of the present invention, therefore, is to provide an alternative design of a hand-held power tool with which a selection may be reliably made between at least two different maximum transmissible torques using just one switch.

### Technical Solution

The present invention is based on the idea of providing at least one second overload clutch in addition to the first overload clutch, and to assign it exclusively to a first gear unit, so that the second overload clutch is automatically activated when the first gear unit is engaged in the drive train in order to transfer torque. In other words, the second overload clutch with the first gear unit forms one functional unit which may be activated or deactivated exclusively in entirety. This makes it possible to switch to the first gear unit which includes the second overload clutch—which is tailored to the first gear unit and is non-adjustable, in particular—using a single switch which is a rotary knob in particular. Advantageously, a separate switch for switching between the overload clutches is not required. If a switch is made from the first gear unit to the second gear unit using the single switch, the second overload clutch is automatically deactivated or disengaged from the drive train. It is within the scope of the present invention to provide further overload clutches in addition to the first and second overload clutches, and to preferably assign each overload clutch to a separate gear unit.

In the context of the present invention, a “gear unit” refers to a single transmission gear which is designed as a spur gear in particular, and to a plurality of gear wheels which are coupled to one another in a non-rotatable manner, and which are situated in a manner such that they are rotatable only as a whole. It is advantageous when different gear wheels in one gear unit have different diameters, thereby making it possible for an overload clutch to be effective at different gear ratios.

Advantageously, the at least two overload clutches are sized differently, thereby making it possible to transfer maximum torques of different magnitudes. The maximum torque to be transferred, i.e. the triggering torque of the first overload clutch, is preferably greater than that of the second overload clutch.

A system is advantageous in which at least two gear wheels of the first gear unit have different diameters, and at least one gear wheel of the second gear unit has the same diameter as at least one of the gear wheels of the first gear unit. This makes it possible to realize the same gear ratio using two gear units, the effective triggering torques being different. It is possible, for example, to use diamond bits with large diameters at a low rotational speed of the tool shaft and a low triggering torque. By switching the gear units while keeping the diameter of the active gear wheel the same, it is possible to realize the same low rotational speed with a high triggering torque, thereby making it possible, for example, to work with long wood screws.

There are different possibilities for the implementation of the first overload clutch. For example, the first overload clutch may be operatively connected permanently and exclusively with the second gear unit. In a design of this type, both overload clutches are in use, exclusively in an alternating manner. When the first gear unit is selected using the single switch, the second overload clutch is automatically active; when switching to the second gear unit, only the first overload clutch—which forms one functional unit together with the second gear unit—is active.

It is also feasible to assign the first overload clutch to all gear units, i.e. to preferably situate it in the drive train in a manner such that it is always active in a torque-limiting manner. A bridge device may also be provided for the first overload clutch. In the embodiment in which the first overload clutch operates for all gear units, it is a substantial advantage when the first overload clutch is designed to be harder than the second overload clutch. The first overload clutch may be designed, e.g. as a rigid, locking clutch, and the second overload clutch may be designed as a friction clutch.

When the first overload clutch is assigned to all or one group of gear units, it is preferable for only the first overload clutch to be active when the second gear unit is operated in a torque-transferring manner. When the single switch is used to switch to the first gear unit, the second overload clutch which is operatively connected to the first gear unit automatically becomes active, too, thereby making it possible overall to transfer the triggering torque of the weaker, second overload clutch only as a maximum torque. In the configuration described, an overload clutch is not exclusively assigned to the second gear unit.

Embodiments are also feasible, however, in which the second overload clutch acts on all gear units in a torque-limiting manner, and in which separate overload clutches are assigned to each gear unit in a plurality of gear units.

For reasons of production and assembly, it is advantageous when the gear units which transfer torque at different times are located on a motor shaft or a countershaft which is located in the drive train between the motor shaft and the tool shaft. The countershaft is preferably driven by the motor shaft, via a spur gearbox. In the latter embodiment, it is advantageous when the first gear unit is assigned to this spur gearbox, i.e. when it acts on all gear units which are located on the countershaft.

In order to activate the different gear units to at least one of which an overload clutch is permanently and exclusively assigned, it is feasible to assign—on the tool shaft—at least one output gear unit and at least to one output gear wheel to each gear unit, so that, by displacing an axially displaceable key, it is possible to make a selection between the different output gear units and, therefore, between the different gear units. Using the key, a non-rotatable connection is established between the selected output gear unit and the tool shaft. Non-selected output gear units are rotatable relative to the tool shaft and therefore do not transfer torque, i.e. they are disengaged from the drive train. In the configuration described, the gear units are non-rotatably connected to the countershaft. It is also feasible to situate the output drive unit on the countershaft in a non-rotatable manner, and to make a direct selection between the axially adjacent gear units, e.g. using an axially displaceable key.

According to an alternative embodiment, it is feasible to provide at least one output gear unit which is non-rotatably connected to the tool shaft but which may be displaced axially relative to the tool shaft. Preferably, several output gear wheels having different sizes are non-rotatably coupled to one another as a single output gear unit. Via the axial displacement of the output gear unit designed in this manner it is possible to make a selection between the different gear units, an overload clutch being permanently assigned to at least one of the gear units.

### BRIEF DESCRIPTION OF THE DRAWING

Further advantages, features, and details of the present invention result from the description of preferred embodiments, below, and with reference to the drawing, which shows:

FIG. 1a a schematic depiction of a hand-held power tool which includes a two-stage gearbox and two overload clutches,

FIG. 1b shows a switch for simultaneously selecting the gear ratio and the maximum torque to be transmitted for the hand-held power tool shown in FIG. 1a,

FIG. 2a shows an alternative hand-held power tool with a gearbox and two overload clutches,

FIG. 2b shows a control switch that belongs to the hand-held power tool in FIG. 2a,

FIG. 3a shows an alternative hand-held power tool with a gearbox and two overload clutches, and

FIG. 3b shows a switch for a hand-held power tool in FIG. 3a.

### EMBODIMENTS OF THE INVENTION

Identical components and components with the same functionality are labelled with the same reference numerals in the figures.

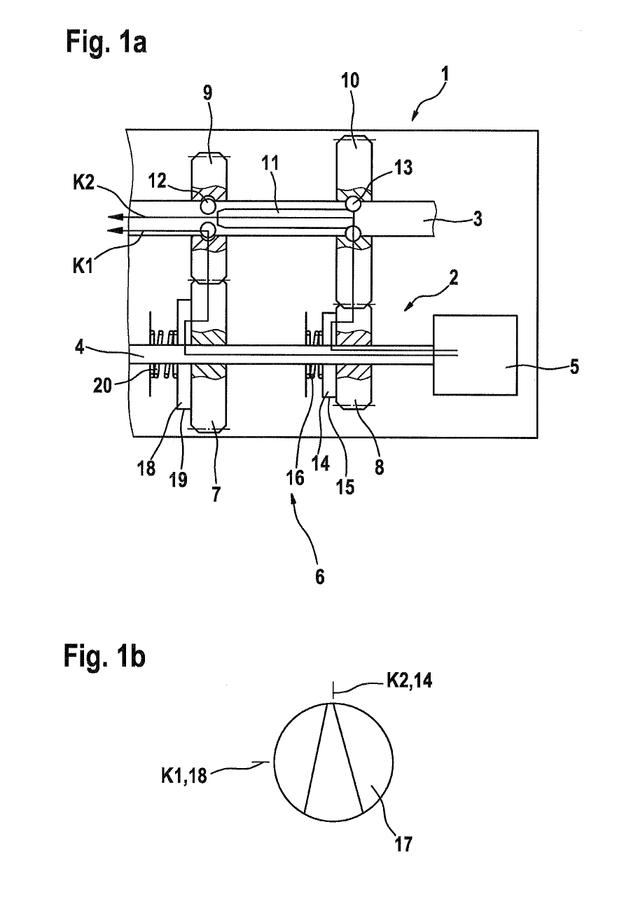

FIG. 1 shows a schematic depiction of a hand-held power tool 1, e.g. a power drill.

Drive train 2 of hand-held power tool 1 includes a tool shaft 3. A tool, e.g. a drill chuck including a drill, is mounted (not depicted) on the left—as shown in the drawing—end of tool shaft 3. A motor shaft 4 of a drive 5 designed as an electric motor is situated parallel to tool shaft 3. Torque is transferred between motor shaft 4 and tool shaft 3 via a gearbox 6 which includes a first gear unit 7 composed of a single gear wheel, and an axially adjacent, second gear unit 8. A first output gear unit 9 composed of a single gear wheel is assigned to first gear unit 7, and a second output gear unit 10 composed of a single gear unit is assigned to second gear unit 8.

First or second output gear unit 9, 10 may be connected in a non-rotatable, i.e. torque-transferring, manner to tool shaft 3 using a key 11 which is displaceable in the axial direction. A form-fit connection is established using key 11 via driving balls 12, 13. In FIG. 1a, second output gear unit 10 is non-rotatably connected to tool shaft 3, while first output gear unit 9 is rotatable relative to tool shaft 3.

A first overload clutch 14 which is designed as a friction clutch is assigned exclusively to second gear unit 8, via which the torque from the motor shaft is transferred to second gear unit 8, first overload clutch 14 limiting the maximum torque to be transferred. First overload clutch 14 includes a friction plate 15 which is displaceable in the axial direction relative to motor shaft 4 and is non-rotatably connected to motor shaft 4; friction plate 15 is acted upon in the direction of second gear unit 8 by spring force of springs 16. First overload clutch 14 is active in a torque-transferring or torque-limiting manner only when second gear unit 8 is operated in a torque-transferring manner.

A switch 17 which is designed as a rotary knob is provided in order to switch between second gear unit 8 and first gear unit 7 (see FIG. 1b). Switch 17 may be moved from the switch position (K2, 14) shown, in which first overload clutch 14 is active and a power flow K2 is realized (active second gear unit 8), into a switch position (K1, 18) which is rotated by 90°, thereby displacing key 11 (via a non-depicted gearshift linkage) to the left as shown in the drawing. In this switch position, only first output gear unit 9 is non-rotatably connected (in a form-fit manner) to the tool shaft, so that first gear unit 7 with an associated second overload clutch 18 is active in a torque-transferring manner. Second overload clutch 18 is also provided with a friction plate 19, which is acted upon with spring force with the aid of springs 20 in the axial direction toward first gear unit 7. As an alternative, first or second overload clutch (14, 18) may be designed, e.g. as a rigid, locking clutch. In the second switch position, power flow K1 via tool shaft 3, friction plate 19, first gear unit 7, first output gear unit 9, and tool shaft 3 acts on the tool, which is not depicted.

Overload clutches 14, 18 are active exclusively in an alternating manner, and each of which together with associated gear unit 7, 8. By switching between the two gear units 7, 8, a switch is simultaneously made between two different maximum torques, it being preferably possible to transfer a higher maximum torque using first overload clutch 14.

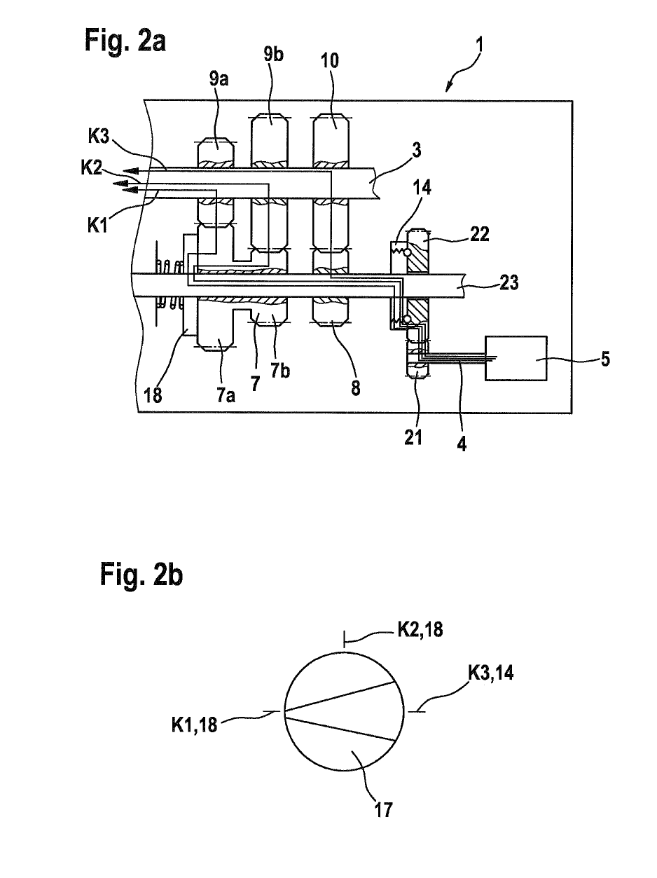

An alternative embodiment of a hand-held power tool 1 is shown in FIG. 2a. Drive 5, which is also designed as an electric motor, drives motor shaft 4 in a rotating manner. A first spur gear 21 which interacts in a torque-transferring manner with a second spur gear 22 is mounted on motor shaft 4. Second spur gear 22 is situated coaxially with countershaft 23, the torque being transferred from second spur gear 22 to countershaft 23 via a first overload clutch 14 which is designed as a rigid, locking clutch.

A second gear unit 8 which is composed of a single gear wheel, and a first gear unit 7 having two gear wheels 7a, 7b which are non-rotatably connected to one another and differ in size are non-rotatably mounted on countershaft 23. A second overload clutch 18 (friction clutch) is assigned to first gear unit 7.

Output gear units 9a, 9b, each of which is composed of one output gear wheel, are each assigned to gear wheel 7a, 7b of first gear unit 7, it being possible to operate output gear units 9a, 9b in a torque-transferring manner independently of one another. An output gear unit 10 having a single output gear wheel is assigned to second gear unit 8. By displacing a non-depicted key, it is possible to select between the three output gear units 9a, 9b, 10 in alternation. First overload clutch 14 is designed to be harder than second overload clutch 18.

In the switch position (K1, 18) shown in FIG. 2b, power flow K1 from drive 5 is applied via spur gears 21, 22, first overload clutch 14, countershaft 23, gear wheel 7a, output gear unit 9a, and tool shaft 3. As shown in FIG. 2a, first overload clutch 14 is assigned to both gear units 7, 8, that is, it is permanently active in a torque-transferring or torque-limiting manner.

In the switch position (K1, 18) shown, a high rotational speed of tool shaft 3 is realized with a low triggering torque (second overload clutch 18). This setting is suitable, e.g. for drilling with diamond bits having small to moderate diameters.

When gear wheel 7a or 7b, i.e. first gear unit 7, is activated, both overload clutches 14, 18 are cumulatively active and, as a result, only the triggering torque of the weaker, second overload clutch 18 is active.

In the second switch position (K2, 18), second power flow K2 is realized via second gear wheel 7b of first gear unit 7. A low rotational speed of tool shaft 3 with a small triggering torque is therefore realized. This setting is suitable, e.g. for drilling with diamond bits having very large diameters.

In the third switch position (K3, 14), power flow K3 travels via second gear unit 8 and output gear unit 10; second gear unit 8 is non-rotatably mounted on countershaft 23 without an overload clutch. Only first overload clutch 14 with a high triggering torque is active. The diameter of gear wheel 7b of first gear unit 7 corresponds to the diameter of the gear wheel of second gear unit 8. It is therefore possible to realize low rotational speeds of tool shaft 3 with a high triggering torque, which is suitable, e.g. for rotating very large, long wood screws.

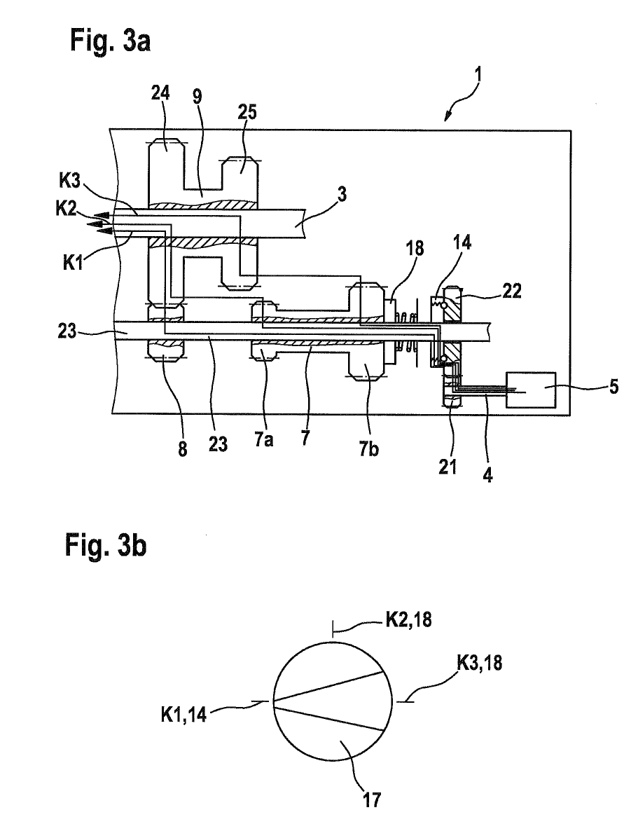

In the embodiment shown in FIGS. 3a and 3b, a single output gear unit 9 with two gear wheels 24, 25 which are non-rotatably coupled to one another is provided on tool shaft 3. Output gear unit 9 is axially displaceable on tool shaft 3 using switch 17 shown in FIG. 3b and a non-depicted gearshift linkage, and it is non-rotatably connected to tool shaft 3 in every displacement position.

Second gear unit 8 without a separate overload clutch, and first gear unit 7 having two gear wheels 7a, 7b are non-rotatably mounted on countershaft 23; the diameter of gear wheel 7a of first gear unit 7 corresponds to the diameter of the gear wheel of second gear unit 8. Second overload clutch 18 which is designed as a friction clutch is assigned exclusively to first gear unit 7. From motor shaft 4 which is driven by drive 5, the torque is transferred to countershaft 23 via spur gears 21, 22 and via first overload clutch 14 which is assigned to second spur gear 22.

In the switch position shown (FIG. 3b) (K1, 14) power flow K1 travels initially via spur gears 21, 22 and first overload clutch 14 to countershaft 23, and, from there, via second gear unit 8 which is non-rotatably connected to countershaft 23 to first, larger gear wheel 24 of output gear unit 9, and, from there, to tool shaft 3. In this switch position, a low rotational speed of tool shaft 3 is combined with a hard triggering torque (first overload clutch 14). This setting is suitable, e.g. for screwing large, long wood screws.

In a second switch position (K2, 18), in which gear wheel 24 interacts with gear wheel 7a, a low rotational speed of tool shaft is also realized, but with a soft triggering torque (second overload clutch 18). This setting is suitable, e.g. for use with diamond bits having very large diameters.

In the third switch position (K3, 18), high rotational speeds of tool shaft 3 are combined with a soft triggering torque. This setting is suitable for use with diamond bits having small to moderate diameters.

What is claimed is:

1. A hand-held power tool (1), in particular an electrical hand-held power tool, with a drive (5), a tool shaft (3), a first overload clutch (14), and a gearbox (6) with a first and at least one second gear unit (7, 8), it being possible to operate the gear units (7, 8) in alternation in a torque-transferring manner,
wherein
at least one second overload clutch (18) is provided, which is operatively connected permanently and exclusively to the first gear unit (7).

2. The hand-held power tool as recited in claim 1,
wherein
the overload clutches (14, 18) are designed to transfer different maximum torques, and preferably wherein the first overload clutch (14) is designed to be harder than the second overload clutch (18).

3. The hand-held power tool (1) as recited in claim 1,
wherein
at least two gear wheels (7a, 7b) of the first gear unit (7) have different diameters, and the second gear unit (8) includes at least one gear wheel (8a, 8b), the diameter of which corresponds at least approximately to the diameter of one of the gear wheels (7a, 7b) of the first gear unit (7).

4. The hand-held power tool as recited in one of the preceding claim 1,
wherein
the first overload clutch (14) is operatively connected permanently and exclusively to the second gear unit (8).

5. The hand-held power tool as recited in claim 1,
wherein
the first overload clutch (14) is assigned to all or one group of gear units (7, 8).

6. The hand-held power tool as recited in claim 5,
wherein
the first overload clutch (14) is situated in the drive train (2) between the drive (5) and the tool shaft (3), in particular between a motor shaft (4) which is driven by the drive (5), and a countershaft (23).

7. The hand-held power tool as recited in claim 5,
wherein
the second gear unit (8) is designed without an overload clutch, or it is provided with a third overload clutch.

8. The hand-held power tool as recited in claim 1,
wherein
the gear units (7, 8) are situated on a countershaft (23).

9. The hand-held power tool as recited in claim 8,
wherein
at least one output gear unit (9, 9a, 9b, 10) which is connectable in a non-rotatable manner to the tool shaft (3), in particular via an axially displaceable key (11), is assigned to each of the gear units (7, 8).

10. The hand-held power tool as recited in claim 8,
wherein
at least one output gear unit (9, 9a, 9b, 10) which is connectable in a non-rotatable manner to the tool shaft (3) and is axially displaceable relative to the tool shaft (3) is provided.
